(19) United States
(12) Patent Application Publication
(10) Pub. No.: US 2011/0226744 A1
(43) Pub. Date: Sep. 22, 2011

(54) Method For Regulating Energy Input of a Pulsed Arc Plasma During a Joining Process and Apparatus

(76) Inventors: Dr.-Ing. Gerd Heinz, Berlin (DE); Dr.-Ing.Heinz Schopp, Berlin (DE); Dipl.-Ing. Frank Hoftmann, Berlin (DE); Gregor Gott, Greifswald (DE)

(21) Appl. No.: 13/062,139

(22) PCT Filed: Sep. 3, 2009
(86) PCT No.: PCT/DE09/01216

§ 371 Date: May 24, 2011

(30) Foreign Application Priority Data
Sep. 3, 2008 (DE) 10 2008 045 501.6
Sep. 3, 2009 (DE) PCT/DE2009/001216

(51) Int. Cl. B23K 10/02

(52) U.S. Cl. 219/121.46; 219/121.45

(57) ABSTRACT

The disclosure provides a method and apparatus for regulating an energy input of a pulsed arc plasma during a joining process by detecting first measurement signals for a first temporal response of emission light from an arc plasma in a first spectral range with a first photodiode, which has a sensitivity maximum at a first wavelength, detecting second measurement signals for a second temporal response of emission light from an arc plasma in a second spectral range, which is at least partially different from the first spectral range, with a second photodiode having a sensitivity maximum at a second wavelength that is different from the first wavelength, generating control signals by comparing the first measurement signals and the second measurement signals, and regulating an energy source, which is configured to provide energy in pulsed form for the arc plasma in accordance with the control signals.

### CROSS-REFERENCE TO RELATED APPLICATION

This application is a National Stage filing of International Application Serial No. PCT/DE2009/001216, filed 3 Sep., 2009 and designating the United States, which claims priority to German Patent Application No. 10 2008 045 501.6 filed 3 Sep., 2008, the disclosures of which are expressly incorporated herein by reference.

### FIELD OF THE DISCLOSURE

The disclosure relates to a method and apparatus for regulating an energy input of a pulsed arc plasma during a joining process.

### BACKGROUND OF THE DISCLOSURE

Attempts to influence the energy input in pulsed welding processes by measurement and regulation of welding current and welding voltage exist in the prior art and function adequately well down to sheet metal thicknesses of 0.7 millimeters.

The thinner the metal sheets to be joined however, the more the current welding processes become unstable. Oxidation areas, material warping or separation errors lead to fairly frequent perforation of the sheet metal. On the one hand the energy input has to be high enough to generate an intimate material connection, and on the other hand the energy input is not to be allowed to become that great that the weld seam or the welding alloy fails.

Various studies have been carried out with the aim of stabilizing the energy input by taking into account additional influencing variables. These have shown that some types of spectral information can give useful indications about the behaviour of the process. In the literature there is a predominance of studies into spectral lines of the materials involved, in order to draw conclusions about the process.

In Han GuoMing et al.: Acquisition and pattern recognition of spectrum information of welding metal transfer., Materials & Design, Vol. 24, Issue 8, December 2003, pp. 699-703 a technique is described for examining the arc light spectrum using pattern recognition methods. Correctly welded joints are used as training patterns. A minimum-distance classifier was developed in order to extract various features.

In Li et al.: Precision Sensing of Arc Length in GTAW Based on Arc Light Spectrum., Journal of Manufacturing Science and Engineering, February 2001, Vol. 123, Issue 1, pp. 62-65 the authors attempt to use spectral methods to determine the length of the light arc in the Gas Tungsten Arc Welding (GTAW) process. At a wavelength of 696.5 nm; +/−15 nm it is possible to determine the arc light to +/−0.2 mm.

In Li et al.: Spectral Information of Arc and Welding Automation, Welding in the World, Vol. 34, (1994) 317-324 and in Li Junyue et al.: Basic theory and method of welding arc spectral information, Chinese Journal of Mechanical Engineering 2004/02 a set of twelve equations for modelling spectral characteristics of the light arc is given. Using these as a starting point it is possible to draw different conclusions as to the state of the light arc and the changes in the state.

In Valensi et al.: Experimental study of a MIG-MAG welding arc., 13th International Congress on Plasma Physics, ICPP 2006, Kiev, May 22-26, 2006 an overview is given of the ways in which modern methods of plasma physics can be applied. With a line spectrometer hypotheses can thus be investigated on the droplet transfer and on the effect of the protective gas, leading to such conclusions as e.g.: “The plasma temperature does not seem to exceed 20,000 Kelvin.”

In Li et al.: Analysis of an Arc Light Mechanism and Its Application in Sensing of the GTAW Process., Welding Research Supplement, September 2000, 252-260 the Gas-Tungsten Arc Welding Process (GTAW) is investigated with spectral methods. By filtering out the argon ion lines and the metal atomic lines a relation can be derived for the light arc length to +/−0.2 mm.

In Ancona et al.: Optical Sensor for real-time Monitoring of CO2 Laser Welding Process., Applied Optics, Vol. 40, Issue 33, pp. 6019-6025 the emission lines of three elements are determined by line spectrometry, in order to gain information on the plasma temperature. A correlation is established between the mean value and standard deviation of the temperature of the plasma electrons and the quality of the weld joint. The measurement system does not work in real time however.

In the paper Vilarinho et al.: Proposal for a Modified Fowler-Milne Method to Determine the Temperature Profile in TIG Welding., J. of the Braz. Soc. of Mech. Sci. & Eng. January-March 2004, Vol. XXVI, No. 1/35 calculation principles are proposed for deriving parameters, such as light arc length or temperature, from the spectrum and optical information. For 40 Ampere (˜1 . . . 2 kW) temperatures up to 10,000 Kelvin are calculated. However, the method is not suitable for control in real time.

A line-spectrometric variant is described in document DE 10 2004 015 553 A1. The idea here is to control the energy input of a welding process by means of spectral decomposition of the plasma light. A line spectrometer is intended to provide control information that controls the welding device. A similar proposal is made in a paper by Mirapeix et al.: “Embedded spectroscopic fiber sensor for on-line arc-welding analysis” Applied Optics, Vol. 46, Issue 16, June 2007, pp. 3215-3220. An optical fibre cable is embedded in the protective gas tube, and a very efficient facility is obtained for transmitting the light of the arc to a spectrometer without intrusion into the burner head.

In the article Mirapeixet al.: “Fast algorithm for spectral processing with application to on-line welding quality assurance” Measurement Science and Technology, 17, (10), 2623-2629, 2006 by the same authors, an algorithm is described with which it is possible to analyse welding processes based on single lines. Here, a processing time of twenty milliseconds is obtained for the analysis of multiple lines (multiple peak analysis) on a conventional PC.

On spectral methods, an overview of recent research can be found on the internet at http://www.ilib.cn/A-jxgcxb-e200402036.html.

A problem of the known methods is the extremely high temperature changes. If an instantaneous power of around ten kilowatts is introduced into a plasma one cubic millimetre in size, temperature changes of several million Kelvin per second are produced. If a controller is to switch off the welding pulse in real time, only a few microseconds are available to do so. As software-implementations only controllers with delays in the millisecond range are known. Since the welding current source cannot be made arbitrarily fast, it is necessary to minimise the delay of the spectral regulator as far as possible.

In order to achieve the shortest adjustment times, one must be able to efficiently use the number of photons available in a temporal and spectral interval. Noise levels and spectral bandwidth are thereby closely related to each other: the lower the bandwidth and the sensor area, the higher the noise level. Or conversely: the higher the bandwidth and size of the photosensors, the lower the noise in a bounding time interval.

A further problem of known methods of thermography, bolometry or pyrometry consists in the fact that attempts are made to extract information from only one spectral range. In the process of production and use of a spectral regulator for welding machines however, many variations must be considered: such a regulator would therefore indicate different values in the event of contamination or variations in separation distance. Rather, an approach based on a difference principle is therefore recommended.

Now it is known, (see ISBN 3-8167-6766-4, www.irb.fraunhofer.de, page B41, or http://www.choparc.de/ergebnis_inp.pdf (page 14 of 16 Sep. 2004) or document DE 10 2004 015 553 A1 (WO/2005/051586), that in the case of pulsed arcs, individual emission intensities of the protective gas lines and the metallic lines show converse behaviours. The intensity of an argon emission in the infrared falls off rapidly, while the emission of a line of metal vapor of the plasma in the ultraviolet increases with the current pulse time.

### SUMMARY OF THE DISCLOSURE

The present disclosure provides a method and apparatus for regulating an energy input of a pulsed arc plasma during a joining process, which facilitate as time-efficient a regulation of the energy input as possible in real time. It is intended to enable their use both for the simplest energy sources for welding or soldering equipment as well as for standard commercial devices with an internal timer. Furthermore, the apparatus is to support a construction with the lowest possible space requirements and in a form that is easily handled.

The disclosure comprises the notion of a method for regulating an energy input of a pulsed arc plasma during a joining process, in particular during a welding or soldering process, wherein the method comprises the following steps: detection of first measurement signals for a first temporal response of emission light from an arc plasma of the joining process in a first spectral range, detection of second measurement signals for a second response of the emission light from the arc plasma of the joining process in a second spectral range that is at least partially different from the first spectral range, generation of control signals by comparing the first measurement signals and the second measurement signals in an analysis device, and regulation of an energy source, which is configured to provide pulsed energy for the arc plasma, in accordance with the control signals. In the disclosure it is provided that the first measurement signals are detected with a first photodiode, which has a sensitivity maximum at a first wavelength, and the second measurement signals are detected with a second photodiode, which has a sensitivity maximum at a second wavelength that is different from the first wavelength. This means that separate detector devices are used. The detection of the measurement signals using photodiodes has the advantage that cost-effective components are used that are also available in different designs, with which optical signals can be detected with a spectral spread. Furthermore, the use of the photodiodes supports a real-time regulation, since fast response times can be realised.

In addition, the disclosure comprises the notion of an apparatus for regulating an energy input of a pulsed arc plasma during a joining process, in particular in a welding or soldering process, with a measurement device that is configured to detect first measurement signals for a first temporal response of emission light from an arc plasma of the joining process in a first spectral range with a first photodiode having a sensitivity maximum at a first wavelength, and second measurement signals for a second temporal response of emission light from an arc plasma of the joining process in a second spectral range, which is at least partially different from the first spectral range, with a second photodiode having a sensitivity maximum at a second wavelength, which is different from the first wavelength, and an analysis device which is configured to generate control signals by comparing the first measurement signals and the second measurement signals, and to provide the control signals for regulating an energy source for pulsed energy for the arc plasma.

By means of the disclosure the possibility for a real-time regulation of the energy input of the pulsed arc plasma during the joining process is realised, in which the current pulse that is normally used can be switched on or off in the shortest possible time. This preferably occurs in the timescale of a few microseconds. On reaching a specific temperature or a specific metal vapor concentration in the pulsed arc plasma, the device can respond in an extremely short time.

The comparison of the first and the second measurement signals in the analysis device for generating the control signals can involve one or more threshold values, which when they are reached, or fail to be reached, certain control signals are generated. Such threshold values can be pre-set by the user and adapted to the respective application.

During the detection of the first and the second measurement signals, the first and the second spectral ranges can partially overlap. Alternatively, it can be provided that no overlapping is present between the first and the second spectral ranges. The spectral ranges can be, for example, sections in the ultraviolet range and in the infrared range.

The disclosure in one configuration exploits the finding that the temporal behaviour is not strictly bound to fixed groups of optical lines. A statistical analysis of one possible embodiment showed that the divergence of point clouds is higher, the further are mean maxima of photodiodes scattered about a central point at approximately 600 nm. Thus, in one configuration, a blue/red photodiode pair shows a smaller divergence of the point clouds than an ultraviolet/infrared (UV/IR) pair. In qualitatively equivalent signal parameters under quantitatively similar conditions, a higher voltage difference can be obtained with the UV/IR-pairing.

Optical filters can optionally be used in order to apply spectral filtering to the measurement light.

In one embodiment of the disclosure, the regulation of the energy source comprises a regulation of the temperature of the arc plasma. In this embodiment, a temperature of the arc plasma is determined from the first and the second measurement signals, which can then be optionally compared to a pre-set temperature threshold value for the joining process in order to generate the control signals based on the comparison, which are used to provide a temperature regulation of the arc plasma in the joining process.

In one configuration of the disclosure it is envisaged that a rising signal trace is measured for the first measurement signals and a falling signal trace for the second measurement signals.

An embodiment of the disclosure provides that at least the first measurement signals or at least the second measurement signals are converted to a respective comparison measurement signal level before the generation of control signals. During the conversion of the measurement signals to a respective comparison measurement signal level, an attenuation and/or an amplification of the signal level can occur. By means of the measurement signal conversion, the first and the second measurement signals can in particular be brought to a similar or identical signal level.

A further development of the disclosure provides that during the comparison of the first and the second measurement signals the difference between the first and second measurement signals is taken. The difference values determined by the differencing procedure can be compared with one or more threshold values, so that the control signal generation is carried out in accordance with the comparison between difference values and threshold values.

In one embodiment of the disclosure it is envisaged that the control signals are generated as to comprise a signal for switching off the energy source.

An embodiment of the disclosure can provide that by means of a sample-and-hold circuit a pulse lengthening signal is generated for the switch-off signal, if the energy source specifies a pulse start.

In one embodiment of the disclosure it is envisaged that the control signals are generated as to comprise a signal for switching on the energy source.

An embodiment of the disclosure provides that the control signals are generated as to comprise counter-regulation signals for the energy source, with which a current level of the energy source is counter-regulated without switching off the source.

One embodiment of the disclosure provides that the control signals are filtered by means of a low-pass filter. The low-pass filter can be, for example, an adjustable digital filter.

One further development of the disclosure preferably provides that in at least one other spectral range, which is at least partially different from both the first and the second spectral range, further measurement signals for a further temporal response of the emission light from the arc plasma of the joining process are detected and applied in generating the control signals. By doing so a further spectral range can be analysed. To detect the measurement values a further photodiode may be used.

In one embodiment of the disclosure it is envisaged that at least the first measurement signals for a first spectral range comprising multiple spectral lines of the emission light, or at least the second measurement signals for a second spectral range comprising multiple spectral lines of the emission light are detected.

In connection with embodiments of the apparatus for regulating an energy input of a pulsed arc plasma during a joining process, the comments made above in connection with equivalent embodiments of the method for regulating the energy input apply accordingly.

It can be envisaged that the first and the second photodiode are arranged on a burner head. In this case an arrangement on either the outside or the inside of the burner head possible. In another configuration light signals are coupled in via an optical waveguide cable, for example in the form of a fibre-optic cable, which guides the light to the optical detectors, which can then also be arranged separately from the burner head, for example in a welding device.

The first and the second photodiode can be arranged in an exchangeable manner by means of a plug and socket connection on a pre-amplifier board.

In an embodiment, the first and the second photodiode together with a pre-amplifier device and a measurement signal conditioning device are combined in a constructional unit to form a spectral regulator.

In one embodiment the first and the second photodiode are coupled to an analogue-digital-converter, so that the measurement signals can be converted into analogue signals.

A method for regulating the energy input can be designed in one configuration with two photodiodes, the sensitivity maxima of which lie at different wavelengths L1 and L2, wherein two opposite time functions or temporal responses for spectral measurement signals F1* and F2* are observed with the two photodiodes. In this case, in one configuration a first maximum lies at the wavelength L1 in the spectral range in which welding metals primarily emit. A second maximum L2 lies in the range of a protective gas being used (for example argon or helium) and/or an active gas such as CO2. The maximum L1 with the time function F1* preferably lies in the ultraviolet range (UV), the maximum L2 with the time function F2* lies for example in the infrared (IR) range.

If the measurement signals F1*, F2* as measured are amplified by G1 and G2 and recorded as F1=G1 F1*, F2=G2 F2*, this results in a temporal response which approximately corresponds to the emission of single lines. The time function F1 (in the UV range) rises slowly at the start of the pulse and only reaches its maximum at the end of the pulse, while the time function F2 (IR-range) reaches its maximum immediately after the start of the pulse, and then slowly decays.

In order to ensure that dirt or shadowings do not affect the switching result, in one embodiment a differential form is chosen. To this end a further time function F3=F2−F1=G2 F2*−G1F1* is formed. This difference signal F3 rises steeply at the start of the pulse, to subsequently decay slowly down to the minimum. One of the time functions, let it be F1, can further be advantageously negated with an inverter INV, in order to then be able to form the difference F3=F2+(−F1)=F2−F1 with an adder SUM.

If the time function of the photodiodes is F1* and F2* and the amplification of the pre-amplifiers set at G1 and G2, then a switching condition can be derived in two variants using F2/F1=(F2′G2)/(F1′G1). In the quotient form the switching condition can be queried using G1 and G2 in the form F2/F1==1?. It is simpler to implement in microelectronic technology if the query is expressed in the differential form F2−F1==0?. In this case F2/F1=1 also applies on reaching an ideal switching threshold S=0. In reality however, S should be slightly negative, in order to achieve a simple implementation of the switching function. The switch-off threshold is preferably determined in both forms by the relation between the set gain G1 and the gain to be calibrated G2. The variants favour particular applications. Thus, the quotient form is suited to estimating the plasma temperature analytically using a temperature function T(F2, F1). The differential form by contrast is particularly suitable as a fast regulator for the method described here.

In order to obtain reproducible conditions, it may be advantageous in one configuration to correct the difference signal F3=F2−F1 in terms of its level, before a switching signal is derived. Underlying this is the possibility of expanding the quotient form in numerator and denominator with an equal factor k, without changing the switching threshold. To do so the amplitude of the difference signal F3 is set to a defined voltage value with an automatic gain control AGC. This guarantees that small distance variations or dirt particles have no effect on a non-negligibly small threshold value S that is later required in the comparator.

The point of transition of F3 can be characterised by a threshold value S lying slightly below zero and now forms a definite switching threshold at which the temperature or metal vapour concentration in the plasma has reached a critical value. If F3 falls below the value of S, a digital signal COMP is generated from a comparator, which goes to logical ‘high’. If S is exceeded, then COMP goes to ‘low’. The off condition for COMP in this case can be represented in the form F3=F2−F1<S?.

In order to ensure that noise or short sparks (shot noise) do not accidentally switch off the welding pulse too early, in one design a digital low-pass SC can be connected between the signals COMP and STOP as a pulse-shaping element. The digital low-pass necessarily causes a short delay time TD.

A pre-set value for the arc temperature is set with the gains G1 and G2 and is stored for specific processes and materials via a processor μP, for example in the welding machine. They can be reloaded from the memory as required. This means that different materials can be welded at different plasma temperatures, by the corresponding values for G1 and G2 being loaded.

In order to obtain a simple interface to the welding machine, it can be advantageous to provide a serially connectable sample-and-hold circuit W, which maintains the ‘high’ off-level until the welding machine has switched off the pulse by itself. This sample-and-hold circuit may be advantageous in particular when the welding machine is to work in two operating modes:

In a first operating mode (pulsed operation) A the sample-and-hold circuit W is active and extends the STOP signal by a time TW. In this case the welding machine WM starts every pulse and the spectral regulator SR switches this off again.

A second operating mode B, namely a continuous operation or intermittent pulsed operation, can on the other hand be designed without the sample-and-hold circuit W. In this case both the switch-on and the switch-off signal are relayed to the welding machine: when the plasma exceeds a critical temperature (OFF), the stop signal STOP is set to ‘high’ and the welding current source is switched off. When the plasma then falls below the critical temperature again (ON), STOP goes to ‘low’ and the spectral regulator switches the welding current source on again. This means that the plasma temperature is kept permanently in a defined temperature range, the variation of which is defined only by the sum of all process delays.

For better synchronisation of the droplet detachment an intermittent operation can also be used with operating mode B, in which the timer of the welding machine specifies a long pulse, which is chopped up into parts by the spectral regulator.

To obtain an error-free communication with the welding machine, the STOP signal is supplied to the welding machine WM via a differential interface RS (for example RS485, in certain cases also isolated).

Since the signals from the photodiodes are to be amplified on occasion by up to a thousand-fold, and asymmetric signal shapes are present, galvanic coupling of all stages is essential. To implement the gains G1 and G2, specially developed chopper amplifiers are used. For their offset equalization it may be advantageous to generate, with an AUTOSYNC module, a synchronization signal SYNC from the signals F1, F2 and/or F3 that can be used for the chopper amplifiers, which provides the offset equalization in the respective pulse gap.

In order to store the identified adjustable values, for example for G1 and G2, and reload them in a process-dependent manner, a microprocessor μP can be provided which transports setting, test and calibration data from and to the welding machine via an SER interface.

A further variant of the method consists in applying a fixed pre-amplification of the time functions F1, F2 using analogue-digital converters, in order to simulate the spectral regulator, in either hardware or software, in the signal processor of the welding machine that is present anyway. In this variant, no additional SER interface needs to be set up for transferring parameters between spectral regulator and welding machine, and no microprocessor μP is required.

In one configuration the apparatus for regulating the energy input of a pulsed arc plasma is an additional module to the welding machine referred to as a spectral regulator, which is assigned to the welding machine, and which derives a control signal STOP for the welding machine from the plasma light.

In one design the WELD current of a pulsed welding machine is switched off by this spectral regulator and depending on the operating mode A or B, also switched on again. The spectral regulator receives the plasma light by means of two spectrally sensitive photodiodes for different wavelengths L1 and L2 and amplifies and processes it as described in the method to form a control signal STOP for the welding current source.

The spectral regulator in one extension consists of the modules described in the drawings by way of examples. These are: two amplifiers with gains G1 and G2 for the two photodiodes with the function of voltage-current conversion and adjustable signal amplification, a signal inversion INV, a summing circuit SUM, an automatic gain adjustment AGC, a comparator COMP, an adjustable digital low-pass filter used as a delay circuit SC, a switchable sample-and-hold circuit W, a differential or optical interface circuit RS and a circuit for performing autosynchronization AUTOSYNC, a circuit for generating internal operating voltages PWR, a user part BED, a power supply PWR and a microprocessor μP for exchanging the setting, test and calibration data with the welding machine.

If the spectral regulator is implemented in SMD technology, so that it is accommodated in the burner head, then it receives the light via an optically transparent opening in the burner head, or by being arranged on the underside of the burner head so that it looks directly into the light arc.

If on the other hand the spectral regulator is accommodated in the welding machine, then an optical waveguide cable can advantageously be provided between the burner head and the welding machine, which transmits the light from the plasma to the photodiodes.

Depending on the chosen spectral ranges of the photodiodes it may be necessary that an optical waveguide cable of suitable spectral characteristics is used for each photodiode.

Another device relates to exchangeable filters. In some circumstances it can be advantageous to use broadband photodiodes and provide corresponding filter glasses with long-pass, short-pass or band-pass characteristics, which are inserted into the spectral regulator before the photodiodes depending on the type of application.

Another device relates to exchangeable photodiodes. In this case the photodiodes can be arranged on a plug-in circuit board, so that they can be rapidly interchangeable in the event of large differences between welding processes or materials.

### BRIEF DESCRIPTION OF THE DRAWINGS

The disclosure is described in detail in the following, by way of examples, with reference to the different embodiments. The figures show:

FIG. 1 is a graphical illustration of an emission spectrum with spectral lines according to the wavelength for a typical pulsed arc plasma,

FIG. 2 is a graphical illustration of time functions f(t) over time,

FIG. 3 is a block circuit diagram of a spectral regulator with photodiodes,

FIG. 4 is a graphical illustration of time functions f(t) for two operating modes, and

FIG. 5 is a schematic illustration for a combination of a spectral regulator with a pulsed welding machine.

### DESCRIPTION OF EMBODIMENTS OF THE DISCLOSURE

FIG. 1 shows a typical pattern of spectral lines of metals ME to be welded or soldered, and of the protective gas argon AR with its relative emissions EM.

In certain ranges, prominent groups of lines in the emission are circled, which can be assigned to the metals or to the protective gas (or active gas). The relative width of these groups offers the opportunity of using relatively broadband photodiodes. It turns out that a partition is necessary in the range centred on the wavelength LX (approx. 600 nm), in order to obtain a typical time response of the metal lines on the left-hand side and that of the argon lines on the right-hand side. Here, maxima of the sensitivity of the two photodiodes may be chosen for metals at the wavelength L1 (here 420 nm) and for protective gas (argon) at the wavelength L2 (here 780 nm).

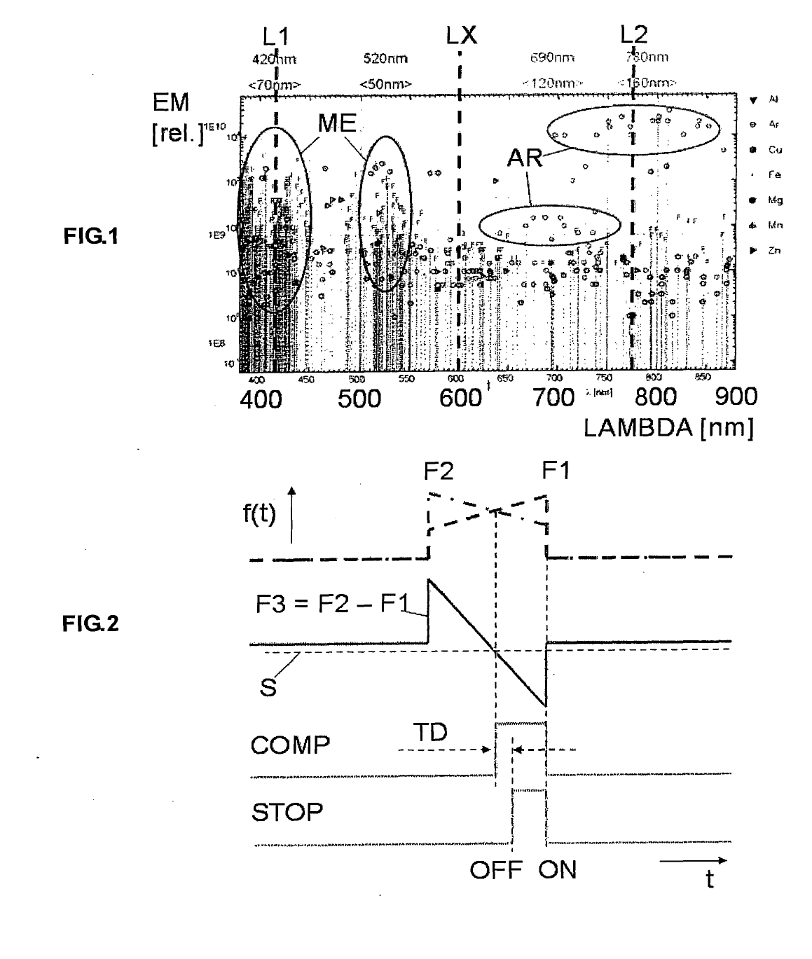

FIG. 2 explains the principles of the function of a spectral regulator with the aid of time functions f(t). The time function F1 to be assigned to the metals rises with time t during the current pulse, the time function F2 assigned to the protective gas or active gas falls off during the current pulse. The time functions F1 and F2, supplied by the two photodiodes and amplified, are subtracted. If F1 becomes greater than F2, then the difference-time function F3=F2−F1 becomes negative. If F3 crosses the slightly negative switching threshold S, then the comparator signal COMP is formed from this. As long as F3 remains below the threshold S, the signal COMP=high. In this case F1 is greater than F2, and in this period the plasma is too energy rich. The ratio G2/G1 of the gains set using the pre-amplifiers determines the switch-off or switch-on temperature. A binary low-pass filter provides spike suppression and introduces a generally negligible additional delay TD, after which the signal STOP is triggered (OFF). If the temperature falls, then the difference-time function F3=F2−F1 rises again, the signals COMP and STOP return to ‘low’ (ON).

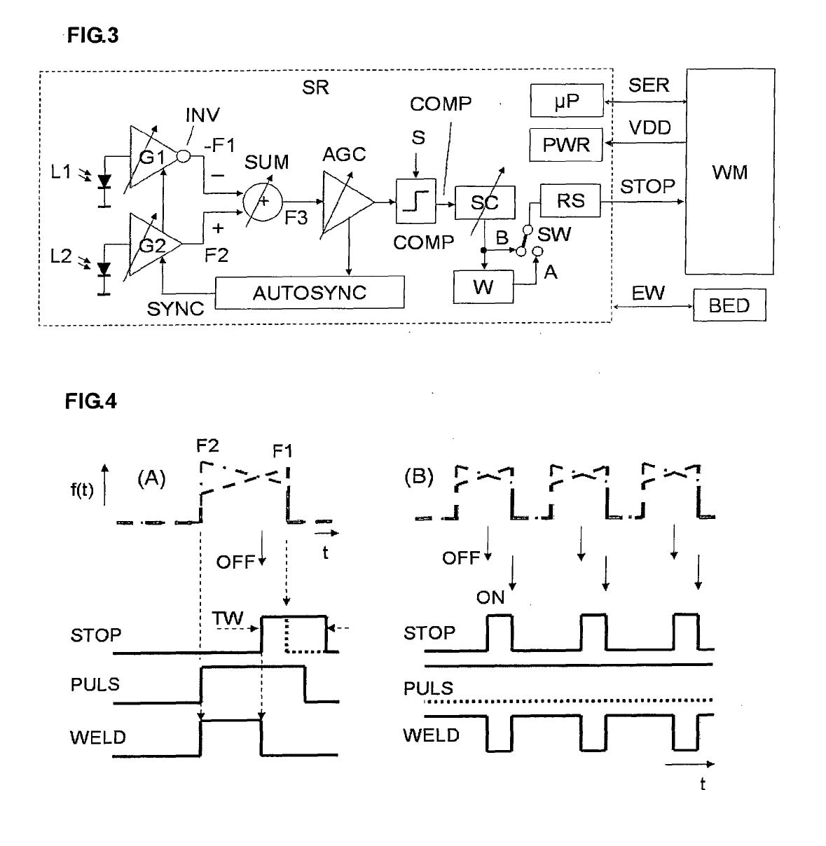

FIG. 3 shows a block circuit diagram of the spectral regulator SR with photodiodes of wavelength-sensitivity maxima L1 and L2, adjustable gains G1 and G2, two time functions F1 and F2, an inverter INV which negates the time function F1−F1, an adder SUM which outputs the difference F3=(F2−F1), an automatic gain control AGC, a circuit for obtaining pulse synchronisation AUTOSYNC, a comparator COMP, which compares at the threshold S, a signal conditioning unit SC (consisting of a digital low-pass with adjustable delay), a switchable sample-and-hold circuit W with switch settings A for pulsed operation and B for quasi-continuous operation, and a digital interface RS, over which the signal STOP is supplied to the welding machine WM. The operating voltage VDD comes from the welding machine WM and is conditioned in a power supply unit PWR. A microprocessor μP communicates with the welding machine WM via an SER Interface. An operator interface BED contains, for example, LEDs or buttons for direct interaction EW with the spectral regulator relating to settings or display values.

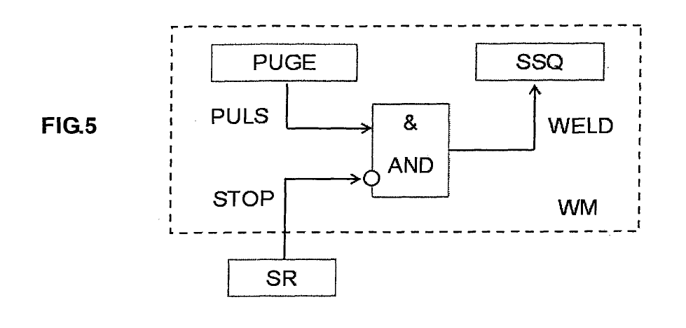

FIG. 4 shows a view of two operating modes using time functions f(t). In a pulsed operation (A) the internal timer of the welding machine starts the current pulse via the signal PULS. When the time function F1 rises above F2, the spectral regulator switches the welding current WELD off, labelled with ‘OFF’ using the STOP signal. In order to prevent the welding machine being switched on again, the STOP level is maintained by the switchable sample-and-hold circuit for a sufficiently further length of time TW, until the internal timer of the welding machine has expired, and PULS is certain to have fallen back again. In the quasi-continuous mode (B) the current of the welding machine is switched on (ON) and switched off (OFF) via the STOP signal. The internal timer of the welding machine is in this mode switched off, while the signal PULS is at the ‘high’ potential. The spectral regulator in this case controls the welding machine. For better synchronisation of the droplet detachment an intermittent operation can also be used with operating mode B, in which the timer of the welding machine specifies a long pulse, which is chopped up into multiple parts by the spectral regulator.

FIG. 5 shows the principle of the combination of the spectral regulator SR with a pulsed welding machine WM. In order to extend the welding machine to include an input for the signal STOP, in the simplest case the connection of the internal pulse generator PUGE to the welding current source SSQ is broken. The signal STOP is inversely AND-ed with an AND-gate: WELD=PULS &/STOP. To obtain the ionisation here the ground current flows unaffected in addition to the pulse current.

The features of the disclosure disclosed in the present description, claims and figures can be of significance both individually and in any desired combination for realization of the disclosure in its various embodiments.

1-19. (canceled)

20. A method for regulating an energy input of a pulsed arc plasma during a joining process, in particular during a welding or soldering process, the method comprising the steps of:
detecting first measurement signals for a first temporal response of emission light from an arc plasma of the joining process in a first spectral range with a first photodiode, which has a sensitivity maximum at a first wavelength;
detecting second measurement signals for a second temporal response of emission light from an arc plasma of the joining process in a second spectral range, which is at least partially different from the first spectral range, with a second photodiode having a sensitivity maximum at a second wavelength, which is different from the first wavelength;
generating control signals, by comparing the first measurement signals and the second measurement signals; and
regulating an energy source, which is configured to provide energy in pulsed form for the arc plasma, in accordance with the control signals.

21. The method according to claim 20, wherein the regulating step comprises regulating the temperature of the arc plasma.

22. The method according to claim 20, wherein a rising signal trace is measured for the first measurement signals and a falling signal trace for the second measurement signals.

23. The method according to claim 20, wherein at least the first measurement signals or at least the second measurement signals are converted to a respective comparison measurement signal level before the generation of control signals.

24. The method according to claim 20, wherein during the comparison of the first and the second measurement signals, a difference between the first and second measurement signals is determined.

25. The method according to claim 20, wherein the control signals are generated so as to comprise a signal for switching off the energy source.

26. The method according to claim 25, wherein a sample-and-hold circuit generates a pulse lengthening signal for the switch-off signal when the energy source specifies the start of a pulse.

27. The method according to claim 20, wherein the control signals are generated so as to comprise a signal for switching on the energy source.

28. The method according to claim 20, wherein the control signals are generated so as to comprise counter-regulation signals for the energy source, with which a current level of the energy source is counter-regulated without switching off the source.

29. The method according to claim 20, wherein the control signals are filtered by a low-pass filter.

30. The method according to claim 20, wherein in at least one other spectral range, which is at least partially different from both the first and the second spectral ranges, further measurement signals for a further temporal response of the emission light from the arc plasma of the joining process are detected and applied in generating the control signals.

31. The method according to claim 20, wherein at least the first measurement signals for a first spectral range comprising multiple spectral lines of the emission light, or at least the second measurement signals for a second spectral range comprising multiple spectral lines of the emission light, are detected.

32. An apparatus for regulating an energy input of a pulsed arc plasma during a joining process, in particular in a welding or soldering process, comprising:
a measurement device that is configured to detect first measurement signals for a first temporal response of emission light from an arc plasma of the joining process in a first spectral range with a first photodiode having a sensitivity maximum at a first wavelength, and to detect second measurement signals for a second temporal response of emission light from an arc plasma of the joining process in a second spectral range, which is at least partially different from the first spectral range, with a second photodiode having a sensitivity maximum at a second wavelength, which is different from the first wavelength; and
an analysis device, which is configured to generate control signals by comparing the first measurement signals and the second measurement signals, and to provide the control signals for regulating an energy source for pulsed energy for the arc plasma.

33. The apparatus according to claim 32, wherein the first and the second photodiodes are arranged on a burner head.

34. The apparatus according to claim 32, wherein the first and the second photodiodes are assembled together with a pre-amplifier device and a measurement signal conditioning device in a constructional unit to form a spectral regulator.

35. The apparatus according to claim 32, wherein the first and the second photodiode are arranged on a pre-amplifier board in an exchangeable manner by means of a plug and socket connection.

36. The apparatus according to claim 32, wherein the first and the second photodiodes are coupled to an analogue-digital-converter.

37. The apparatus according to claim 32, wherein the measurement device is configured to detect further measurement signals for a further temporal response of emission light from an arc plasma of the joining process in a further spectral range, which is at least partially different from the first and the second spectral range.

38. The apparatus according to claim 37, further including a further photodiode to detect the further measurement signals, the further photodiode having a sensitivity maximum at a further wavelength, which is different from the first and the second wavelength.
